(19) United States
(12) Patent Application Publication
(10) Pub. No.: US 2013/0056240 A1
(43) Pub. Date: Mar. 7, 2013

(54) WIRE PROTECTION MEMBER

(71) Applicant: Hideki Kawai, Yokkaichi-City (JP)

(72) Inventor: Hideki Kawai, Yokkaichi-City (JP)

(73) Assignee: SUMITOMO WIRING SYSTEMS, LTD., Yokkaichi-City (JP)

(21) Appl. No.: 13/697,551

(22) PCT Filed: Oct. 29, 2010
(86) PCT No.: PCT/JP2010/069263

§ 371 Date: Nov. 13, 2012

(30) Foreign Application Priority Data
Jun. 15, 2010 (JP) 2010-136006

(51) Int. Cl. H01B 3/48

(52) U.S. Cl. 174/124 R

(57) ABSTRACT

Disclosed is a wire protection member that covers and protects a wire. The wire protection member includes a main body portion that is formed by application of heat and pressure to a nonwoven material so as to cover an outer circumferential portion of a wire bundle and a plurality of protruding portions that is formed by application of heat and pressure to a nonwoven material so as to project outward from an outer circumferential portion of the main body portion.

### BACKGROUND OF THE INVENTION

1. Field of the Invention

The present invention relates to a technology for protecting wires installed in vehicles and the like.

2. Description of the Related Art

Examples of the technology for protecting wires installed in vehicles include a resin casing (also called “protector”) in which a wire can be inserted and accommodated, a molded wire harness (JP 2008-188958A) produced by molding a sheathing member on an exterior of a wire, and the like.

Moreover, as a technology for protecting a wire, a method has been proposed in which a wire is protected by a wire protection member made of a nonwoven material. More specifically, this wire protection member can be shaped by hot pressing the nonwoven material with the wire being covered by the nonwoven material.

A wire protection member such as those described above may come into sliding contact with a neighboring member due to vibration and the like during travel of the vehicle and subject to abrasion, depending on a route in which the wire is installed. In particular, if the wire protection member comes into contact with a projection such as a burr produced by welding of a metal member of a vehicle body, an edge of a neighboring member, or the like, the amount of abrasion may increase, and higher protection performance is required.

Usually, abrasion occurs from an outer circumferential-side end portion of the wire protection member. For this reason, in order to improve the protection performance of the wire protection member, a method of increasing the thickness throughout the wire protection member and thereby increasing a reaching distance to the wire to be protected is conceivable. However, the method of increasing the thickness throughout the wire protection member increases the amount of usage of the nonwoven material that is required to form the wire protection member.

Thus, it is an object of the present invention to obtain high protection performance while suppressing the amount of usage of the nonwoven material.

### SUMMARY OF THE INVENTION

A wire protection member according to a first aspect is a wire protection member that covers and protects a wire, the wire protection member including a main body portion that is formed by application of heat and pressure to a nonwoven material so as to cover an outer circumferential portion of the wire and a plurality of protruding portions that is formed by application of heat and pressure to a nonwoven material so as to project outward from an outer circumferential portion of the main body portion.

A wire protection member according to a second aspect is the wire protection member according to the first aspect, wherein the plurality of protruding portions is provided in a part of the outer circumferential portion of the main body portion in a circumferential direction of the main body portion or in an extending direction of the wire.

A wire protection member according to a third aspect is the wire protection member according to the first or the second aspect, wherein each of the plurality of protruding portions is formed as a ridge extending in the circumferential direction of the main body portion.

A wire protection member according to a fourth aspect is the wire protection member according to the first or the second aspect, wherein each of the plurality of protruding portions is formed as a ridge extending in the extending direction of the wire.

A wire protection member according to a fifth aspect is the wire protection member according to the first or the second aspect, wherein each of the plurality of protruding portions projects from the outer circumferential portion of the main body portion as a raised dot.

With the wire protection member according to the first aspect, the plurality of protruding portions is provided so as to project outward from the outer circumferential portion of the main body portion that covers the outer circumferential portion of the wire. Thus, while the wire protection member can be made of a smaller amount of material when compared to cases where the thickness throughout the wire protection member is increased, a large distance from the outer circumferential-side end portion of the wire protection member to the wire that is covered by the wire protection member, that is, a large reaching distance to the wire can be secured. In this manner, it is possible to obtain high protection performance while suppressing the amount of usage of the nonwoven material.

With the wire protection member according to the second aspect, the plurality of protruding portions is provided partially in the circumferential direction or in the extending direction of the wire. That is to say, the plurality of protruding portions is formed in only a portion in the circumferential direction or in the extending direction of the wire that may come into contact with a neighboring member, and thus it is possible to reduce the amount of the nonwoven material that is used even more.

With the wire protection member according to the third aspect, since the plurality of protruding portions is formed as ridges extending in the circumferential direction of the main body portion, bending deformation of the wire protection member is relatively easy, and the wire can be placed in a manner that follows the shape of a placement area.

With the wire protection member according to the fourth aspect, since the plurality of protruding portions is formed as ridges extending in the extending direction of the wire, the wire protection member is relatively resistant to bending deformation, and the wire can be more stably retained in a predetermined route thereof.

With the wire protection member according to the fifth aspect, since the plurality of protruding portions is formed as raised dots projecting from the outer circumferential portion of the main body portion, the amount of the nonwoven material can be reduced even more.

### BRIEF DESCRIPTION OF DRAWINGS

FIG. 1 is a perspective view of a wire protection member according to a first embodiment.

FIG. 2 is a cross-sectional view taken along line II-II in FIG. 1.

FIG. 3 is a perspective view of a wire protection member in a part of which a plurality of protruding portions is provided.

FIG. 4 is a perspective view of a wire protection member according to a second embodiment.

FIG. 5 is a diagram as viewed from arrow A in FIG. 4.

FIG. 6 is a perspective view of a wire protection member according to a third embodiment.

FIG. 7 is a diagram showing a variation of a plurality of protruding portions of the wire protection member according to the third embodiment.

### DETAILED DESCRIPTION OF THE PREFERRED EMBODIMENTS

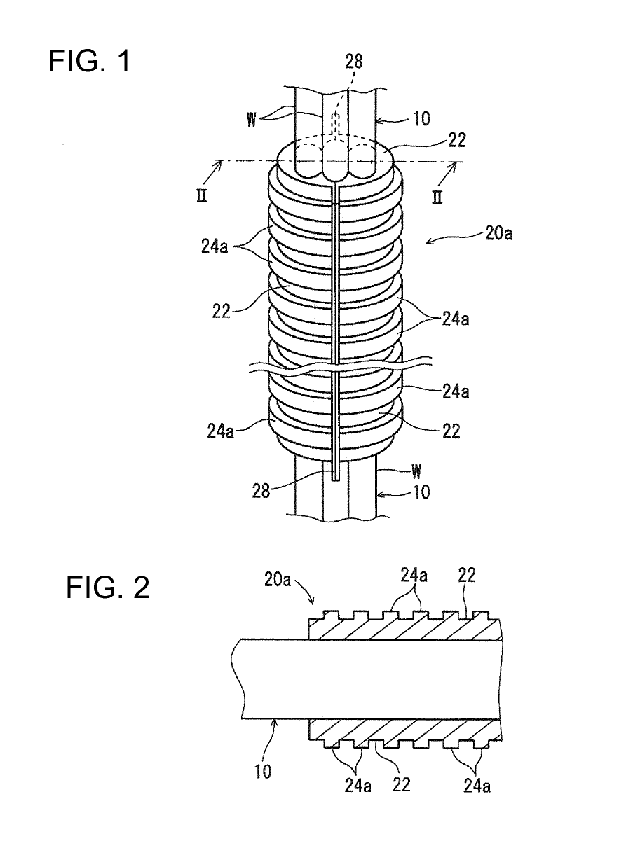

Hereinafter, wire protection members according to embodiments will be described. These wire protection members are each used as a member for covering and protecting wires W (see FIGS. 1, 3, 4, and 6).

Wires constituting a wire harness that is installed in a vehicle or the like are assumed as the wires W. The wires W to be protected by the wire protection member may be a single wire or may be a plurality of wires. Here, an example in which a wire bundle 10 in which the wires W are bundled together is to be protected will be described.

The wire protection member is formed by applying heat and pressure to a nonwoven material. More specifically, the wire protection member is shaped mainly by hot pressing, but there also are cases where a whole wire protection member is formed by shaping a portion by hot pressing and then bonding another nonwoven material to this portion by application of heat.

It should be noted that “hot pressing” herein refers to a process for giving a particular shape to a nonwoven material by sandwiching the nonwoven material to be processed between dies and applying pressure while heating the dies.

Any nonwoven material that can be hardened through the application of heat can be used as the nonwoven material. As an example of such a nonwoven material, a nonwoven material containing a base fiber and an adhesive resin (also called “binder”) can be used. The adhesive resin is a resin having a lower melting point than the melting point of the base fiber. The nonwoven material is heated to a temperature that is lower than the melting point of the base fiber and higher than the melting point of the adhesive resin. As a result, the adhesive resin is melted and soaks into the base fiber. After that, when the temperature of the nonwoven material decreases, the adhesive resin solidifies. In this manner, the nonwoven material is hardened by application of heat, and thus the nonwoven material can be maintained in a shape that is given during the application of heat. This nonwoven material is usually formed into a sheet shape (also called “nonwoven fabric”), and the following description also assumes that the nonwoven material is sheet-shaped.

Any fiber that is capable of maintaining its fibrous state at the melting point of the adhesive resin can be used as the base fiber, and various types of fibers including resin fibers can be used. Moreover, a thermoplastic resin fiber having a lower melting point than the melting point of the base fiber can be used as the adhesive resin. For example, an exemplary combination of the base fiber and the adhesive resin is a combination of a resin fiber of PET (polyethylene terephthalate), which is used as the base fiber, and a copolymer resin of PET and PEI (polyethylene isophthalate), which is used as the adhesive resin.

Hereinafter, a wire protection member 20a according to a first embodiment will be described (see FIGS. 1 and 2). This wire protection member 20a is formed so as to be able to cover the wire bundle 10. Here, the wire protection member 20a is formed by hot pressing a nonwoven material in a state in which it covers a portion to be protected of the wire bundle 10 in a longitudinal direction. However, it is also possible that the wire protection member 20a covers the entire wire bundle 10 in the longitudinal direction.

This wire protection member 20a has a main body portion 22 and a plurality of protruding portions 24a.

The main body portion 22 is a portion that is formed into a shape that covers an outer circumferential portion of the wire bundle 10 (see FIG. 1). Here, the main body portion 22 is formed so as to have an approximately circular outer circumferential shape when viewed in cross section (a plane approximately orthogonal to an extending direction of the wire bundle 10). An inner portion of the main body portion 22 is shaped so as to follow and be in contact with an outer portion of the wire bundle 10 in such a manner that it encloses the entire circumference of the wire bundle 10. It should be noted that the outer circumferential shape of the main body portion 22 is not limited to an approximately circular shape when viewed in cross section and may also be other shapes such as a polygonal shape when viewed in cross section.

Moreover, the plurality of protruding portions 24a projects outward from an outer circumferential portion of the main body portion 22. Each of the plurality of protruding portions 24a is formed as a ridge that extends in a circumferential direction of the main body portion 22 (see FIG. 1). Here, the plurality of protruding portions 24a each extends over the entire length of the main body portion 22 in the circumferential direction (except the respective positions of joint end portions 28, which will be described later). That is to say, the wire protection member 20a has a shape composed of a series of alternating recessed and protruding portions in the extending direction of the wire bundle 10 (see FIG. 2). The outer circumferential portion of the main body portion 22 constitutes bottom portions of the recessed portions between the plurality of protruding portions 24a.

As shown in FIG. 2, the plurality of protruding portions 24a are each formed into an approximately rectangular shape when viewed in cross section. Alternatively, the plurality of protruding portions 24a may be formed into a triangular shape, a semicircular shape, or other shapes when viewed in cross section.

Moreover, these protruding portions 24a are herein formed in positions that are spaced at regular intervals in the extending direction of the wire bundle 10. However, the present invention is not limited to a case where the protruding portions 24a are provided at regular intervals in the extending direction of the wire bundle 10. For example, the protruding portions 24a may also be provided at narrow intervals in an area where stronger protection is desired and at relatively wide intervals in an area other than this area.

Here, the main body portion 22 and the plurality of protruding portions 24a are integrally formed by hot pressing the nonwoven material. More specifically, the wire bundle 10 is sandwiched between two sheets of a fabric-like nonwoven material, and in this state, hot pressing of the nonwoven material sheets is performed, and thus the wire protection member 20a is shaped. For example, hot pressing can be performed using a pair of dies having recessed and protruding shapes corresponding to the plurality of protruding portions 24a. That is to say, the nonwoven material sheets with the wire bundle 10 sandwiched therebetween are put on one die, and the nonwoven material sheets are given a particular shape by moving the other die relative to this die so as to approach it, and thus the wire protection member 20a covering the wire bundle 10 is obtained. However, in addition to the halved dies, dies split into three or more parts in the circumferential direction of the wire protection member 20a to be shaped may also be used. In this case, a configuration in which the plurality of dies is moved in a radial direction with respect to an axial direction of the wire protection member 20a to be shaped may also be adopted.

In the wire protection member 20a that has been shaped by hot pressing, surface-side portions of the main body portion 22 that are located between the plurality of protruding portions 24a and respective surface-side portions of (or the whole of) the plurality of protruding portions 24a are hardened. Moreover, in this wire protection member 20a, the inner portion of the main body portion 22 to which pressure has been applied follows and is in contact with the outer portion of the wire bundle 10 (see FIG. 1).

Moreover, on either side (in FIG. 1, each of front and back sides in a depth direction) of the wire bundle 10, respective end portions of the two nonwoven material sheets are joined to each other by the effect of application of heat and pressure of hot pressing, and the joint end portions 28 are formed. More specifically, in each portion where the respective end portions of the two nonwoven material sheets come into contact with each other, the adhesive resin that has been melted by the application of heat solidifies, and thus the respective end portions of the two nonwoven material sheets are joined to each other. Due to these joint end portions 28, the wire protection member 20a can be maintained in a state in which it covers the wire bundle 10.

However, the wire protection member 20a may also be formed by enclosing the wire bundle 10 with a single nonwoven material sheet and, in this state, hot pressing the nonwoven material sheet. That is to say, it is possible that the wire bundle 10 is sandwiched between a single folded nonwoven material sheet and hot pressing is performed to join both end portions of the nonwoven material sheet to each other.

Moreover, the wire protection member 20a may also be formed as a separate member from the wire bundle 10. That is to say, the wire bundle 10 may be inserted and disposed in an approximately cylindrical wire protection member that has previously been formed, or the wire bundle 10 may be sandwiched between a pair of approximately semi-cylindrical wire protection members that have previously been formed and the wire protection members then bonded by application of heat, fixed by winding a tape, and so on.

Moreover, with regard to the wire protection member 20a, the present invention is not limited to a case where the main body portion 22 and the plurality of protruding portions 24a are integrally formed by hot pressing. That is to say, the plurality of protruding portions 24a may be bonded, by application of heat, to an outer circumferential surface of the main body portion 22 that has been formed by hot pressing. In this case, it is preferable that the respective surface-side portions of (or the whole of) the plurality of protruding portions 24a to be bonded to the main body portion 22, which has been shaped by hot pressing, are hardened by application of heat and pressure.

Usually, if the wire protection member 20a comes into sliding contact with a neighboring member, abrasion occurs from the outer circumferential-side end portion of the wire protection member 20a, that is, a front end portion of any of the plurality of protruding portions 24a. In the present wire protection member 20a, the plurality of protruding portions 24a is provided so as to project outward from the outer circumferential portion of the main body portion 22 that covers the outer portion of the wire bundle 10. Thus, while the wire protection member can be made of a smaller amount of material than in cases where the thickness throughout the wire protection member itself is increased, a large distance from the outer circumferential-side end portion of the wire protection member 20a (i.e., the front end portion of any of the plurality of protruding portions 24a) to the wire bundle 10 that is covered by the wire protection member 20a, that is, a large reaching distance to the wire bundle 10 can be secured.

Therefore, with the wire protection member 20a according to the above-described first embodiment, it is possible to obtain high protection performance while suppressing the amount of usage of the nonwoven material.

Moreover, since the wire protection member 20a is shaped by the application of heat and pressure to the nonwoven material, the surface-side portions (surface-side portions of the main body portion 22 and the plurality of protruding portions 24a) are hardened. That is to say, in an inside-outside direction of the wire protection member 20a, a portion where the nonwoven material is hardened is present extending from the respective front end portions of the plurality of protruding portions 24a to the outer circumferential-side portion (including a hardened portion inside the outer circumferential portion) of the main body portion 22. Here, the hardened portion of the nonwoven material is more resistant to abrasion than a portion that is not hardened. Moreover, when compared to a wire protection member that is formed under the same conditions regarding the heating time and the pressing force and has a configuration in which the plurality of protruding portions 24a is not provided (the outer circumferential portion has a circular shape when viewed in cross section), the portion in which the nonwoven material is hardened, of the wire protection member 20a, has an increased length in the inside-outside direction of the wire protection member 20a. Also in this respect, the wire protection member 20a has high protection performance against abrasion.

Moreover, with the wire protection member 20a, since the plurality of protruding portions 24a is provided, if the wire protection member 20a comes into contact with a neighboring member, in most cases, the front end portions of the plurality of protruding portions 24a come into contact with that neighboring member. In this contact state, to the side of the plurality of protruding portions 24a, a space is created between the outer circumferential portion of the main body portion 22 and the neighboring member. Thus, even if the neighboring member has a projection such as a burr or an edge, when the wire protection member 20a can be disposed in an orientation and a position that allow the projection to be positioned to the side of the plurality of protruding portions 24a (positioned clear of the plurality of protruding portions 24a), it is also possible to suppress abrasion.

Moreover, since the plurality of protruding portions 24a is formed as ridges extending in the circumferential direction of the main body portion 22, there is an advantage of the relative ease of bending deformation in the extending direction of the wire bundle 10. This enables bending deformation into a shape corresponding to any recessed or protruding shape of an area where the wire bundle 10 is placed, and thus the wire bundle 10 can be placed in a manner that more closely follows the shape of the placement area.

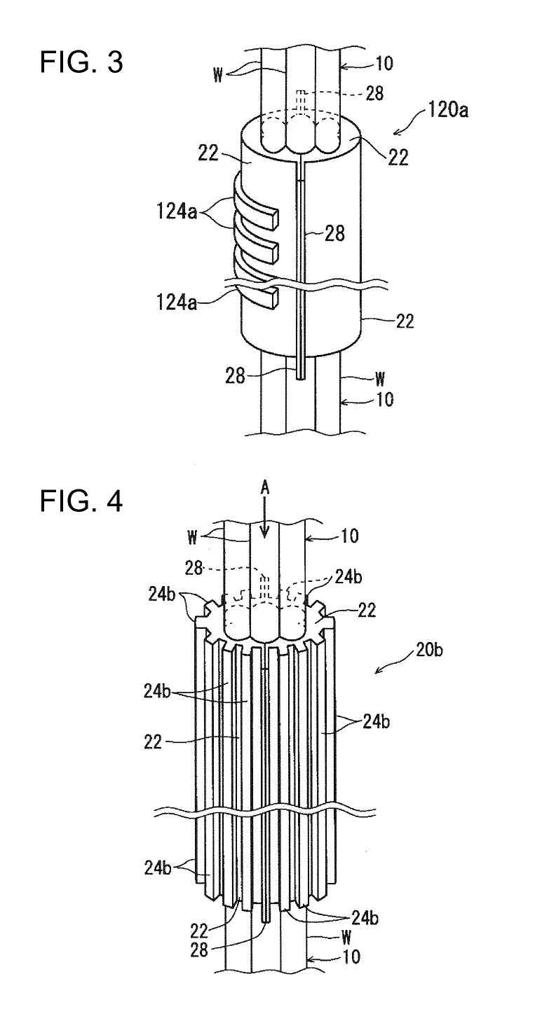

However, the wire protection member 20a is not limited to the above-described configuration. A wire protection member 120a is also conceivable in which a plurality of protruding portions 124a is formed in a part of the outer circumferential portion of the main body portion 22 in the circumferential direction or in the extending direction of the wire bundle 10 (see FIG. 3). That is to say, it is sufficient that the plurality of protruding portions 124a is formed in a portion of the wire protection member 120a that requires higher protection performance, such as a portion to be disposed in an area where there may be a projection, which is likely to cause abrasion, such as a burr or an edge. For example, it is preferable that the plurality of protruding portions 124a is formed, in the circumferential direction of the main body portion 22, within a range that is one-third of the circumference and on a side that comes into contact with a vehicle body and, in the extending direction of the wire bundle 10, in a portion opposing a welded portion (portion where a burr may occur) of the vehicle body.

With a configuration in which the plurality of protruding portions 24a is provided partially in the circumferential direction of the main body portion 22 or in the extending direction of the wire bundle 10 as described above, the same effects as those of the wire protection member 20a can be obtained, and the amount of the nonwoven material that is used can also be reduced even more.

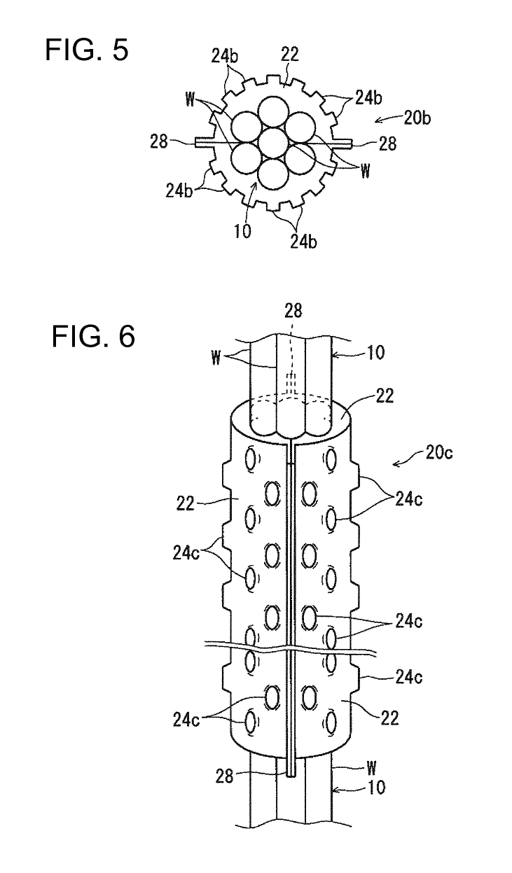

Next, a wire protection member 20b according to a second embodiment will be described (see FIGS. 4 and 5). It should be noted that the same components as those of the wire protection member 20a according to the first embodiment will be denoted by the same reference numerals, and descriptions thereof will be omitted. Moreover, portions of descriptions of a plurality of protruding portions 24b of the wire protection member 20b corresponding to the descriptions of the plurality of protruding portions 24a of the wire protection member 20a will be omitted as well.

In the wire protection member 20b according to the second embodiment, the plurality of protruding portions 24b is formed as ridges on the main body portion 22 that extend in the extending direction of the wire bundle 10. That is to say, the wire protection member 20b has a shape composed of a series of alternating recessed and protruding portions in the circumferential direction of the main body portion 22. Here, these protruding portions 24b are provided in positions (other than the positions of the joint end portions 28) equiangularly spaced in the circumferential direction of the main body portion 22. For example, it is preferable that the protruding portions 24b are provided at intervals of 22.5 degrees.

Moreover, as shown in FIG. 5, each of the plurality of protruding portions 24b is formed into an approximately rectangular shape when viewed in cross section. However, alternatively, each of the plurality of protruding portions 24b may be formed into an approximately triangular shape, an approximately semicircular shape, or other shapes when viewed in cross section.

Moreover, in the wire protection member 20b, as in the case of the wire protection member 20a according to the first embodiment, the plurality of protruding portions 24b may also be formed in a part of the outer circumferential portion of the main body portion 22 in the circumferential direction or in the extending direction of the wire bundle 10.

With the wire protection member 20b according to the above-described second embodiment, as in the case of the wire protection member 20a according to the first embodiment, it is possible to obtain high protection performance while suppressing the amount of usage of the nonwoven material. Moreover, when the wire protection member 20b can be disposed in an orientation and a position that allow a projection such as a burr or an edge to be positioned to the side of the plurality of protruding portions 24b (positioned clear of the plurality of protruding portions 24b), it is also possible to suppress abrasion.

Moreover, since the plurality of protruding portions 24b is formed as ridges extending in the extending direction of the wire bundle 10, the wire protection member 20b is relatively resistant to an external force that acts in a bending direction, so that the wire bundle 10 can be more stably retained in a predetermined route.

Next, a wire protection member 20c according to a third embodiment will be described (see FIG. 6). It should be noted that the same components as those of the wire protection member 20a according to the first embodiment will be denoted by the same reference numerals, and descriptions thereof will be omitted. Moreover, portions of descriptions of a plurality of protruding portions 24c of the wire protection member 20c that correspond to the descriptions of the plurality of protruding portions 24a of the wire protection member 20a will be omitted as well.

In the wire protection member 20c according to the third embodiment, the plurality of protruding portions 24c is formed so as to project from the outer circumferential portion of the main body portion 22 as raised dots. More specifically, these protruding portions 24c are provided in positions spaced apart from one another in the outer circumferential portion of the main body portion 22. Here, the protruding portions 24c are provided in positions spaced at approximately regular intervals in a plurality of rows extending in the circumferential direction of the main body portion 22 and in a plurality of columns extending in the extending direction of the wire bundle 10. However, it is also possible that these protruding portions 24c are provided at narrow intervals in an area where higher protection performance is required and at relatively wide intervals in a portion other than this area.

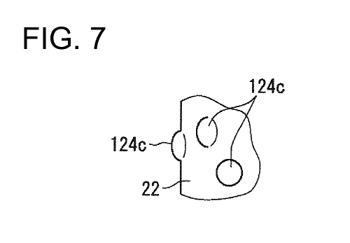

Moreover, the plurality of protruding portions 24c is formed as approximately cylindrical projections projecting from the outer circumferential portion of the main body portion 22 (see FIG. 6). Alternatively, the wire protection member 20c according to the third embodiment may have a configuration in which a plurality of protruding portions 124c is provided as approximately semispherical projections (see FIG. 7). However, the shape of the plurality of protruding portions 24c is not limited to a cylindrical shape and a semispherical shape, and may also be a polygonal column shape, a polygonal pyramid shape, a conical shape, or other shapes.

Moreover, with regard to the wire protection member 20c, as in the case of the wire protection member 20a according to the first embodiment, the plurality of protruding portions 24c may be formed in a part of the outer circumferential portion of the main body portion 22 in the circumferential direction or in the extending direction of the wire bundle 10.

With the wire protection member 20c according to the above-described third embodiment, as in the case of the wire protection member 20a according to the first embodiment, it is possible to obtain high protection performance while suppressing the amount of usage of the nonwoven material. Moreover, when the wire protection member 20c can be disposed in an orientation and a position that allow a projection such as a burr or an edge to be positioned to the side of the plurality of protruding portions 24c (positioned clear of the plurality of protruding portions 24c), it is also possible to suppress abrasion.

Moreover, since the plurality of protruding portions 24c is formed so as to project from the outer circumferential portion of the main body portion 22 as raised dots, the amount of the nonwoven material can be reduced even more when compared to the wire protection members 20a and 20b.

It should be noted that the wire protection member is not limited to the above-described configurations. In addition to these, with respect to the wire protection member, it is possible to adopt configurations in which a mixture of protruding portions selected from, or all of the plurality of protruding portions 24a (124a), 24b, and 24c (124c) are provided in the outer circumferential portion of the main body portion 22. For example, the plurality of protruding portions 24a (124a) and 24b can be provided in an area that is highly likely to be brought into contact with a neighboring member, and in particular, it is preferable to provide the plurality of protruding portions 24a (124a) in a portion where bending deformation or the like is required during installation of the wire bundle 10 and the plurality of protruding portions 24b in a portion where more stable retention is required. Moreover, it is also possible to provide the plurality of protruding portions 24c (124c) in a portion that is less likely to be brought into contact with a neighboring member.

That is to say, in the wire protection member, the plurality of protruding portions 24a (124a), 24b, and/or 24c (124c) can be provided as appropriate for the protection performance that is required according to the installation position of the wire bundle 10 in the vehicle.

Although the wire protection members 20a, 20b, 20c, and 120a have been described in detail above, the descriptions above are in all respects illustrative, and the present invention is not limited to those descriptions. It should be understood that innumerable variations that are not described herein can be envisaged without departing from the scope of the present invention.

1. A wire protection member that covers and protects a wire, comprising:
a main body portion that is formed by application of heat and pressure to a nonwoven material so as to cover an outer circumferential portion of the wire; and
a plurality of protruding portions that is formed by application of heat and pressure to a nonwoven material so as to project outward from an outer circumferential portion of the main body portion.

2. The wire protection member according to claim 1,
wherein the plurality of protruding portions is provided in a part of the outer circumferential portion of the main body portion in a circumferential direction of the main body portion or in an extending direction of the wire.

3. The wire protection member according to claim 1,
wherein each of the plurality of protruding portions is formed as a ridge extending in the circumferential direction of the main body portion.

4. The wire protection member according to claim 1,
wherein each of the plurality of protruding portions is formed as a ridge extending in the extending direction of the wire.

5. The wire protection member according to claim 1,
wherein each of the plurality of protruding portions projects from the outer circumferential portion of the main body portion as a raised dot.
